(19) United States
(12) Patent Application Publication
(10) Pub. No.: US 2009/0036115 A1
(43) Pub. Date: Feb. 5, 2009

(54) SYSTEM AND METHOD FOR TESTING GSM MODULES

(75) Inventor: JUI-CHEN CHANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/124,164

(22) Filed: May 21, 2008

(30) Foreign Application Priority Data
Aug. 3, 2007 (CN) 200710075540.6

(51) Int. Cl. H04Q 7/00

(52) U.S. Cl. 455/423

(57) ABSTRACT

A method for testing GSM modules includes the following steps of: switching a power supply on; controlling the power supply to provide power to a GSM module; generating a command that establishes a connection between the GSM module and a network; transferring the command to the GSM module; signaling the GSM module to invoke the command, and acquiring test data from the GSM module; determining whether the GSM module is normal by determining whether the GSM module is connected to the network; switching the power supply off; and generating a test result.

### BACKGROUND

1. Field of the Invention

The present invention generally relates to the technology field of global system for mobile communication (GSM), and more particularly to a system and method for testing GSM modules.

2. Description of related art

GSM is the most popular standards for mobile phones in the world. GSM is an open standard using digital cellular technology for transmitting voice and data services. GSM provides international roaming capability, which allows users to access the same services when traveling abroad or at home. The international roaming capability gives users seamless and same number connectivity in more than 210 countries in the world.

The mobile phones connect to the GSM network by utilizing GSM modules installed in the mobile phones. In order to ensure the mobile phones can successfully connect to the GSM network, the GSM modules of newly manufactured mobile phones need to pass a performance test. Generally, the manufacturers test whether the GSM modules are able to connect to the GSM network before the GSM modules are installed into the mobile phones. However, many manufacturers test the GSM modules manually, which is inefficient and may result in human errors.

Accordingly, what is needed is a system and method for automatically and accurately testing GSM modules.

### SUMMARY

A system for testing GSM modules is provided. The system includes a controlling device, a command generating module, and a testing module. The controlling device is configured for switching a power supply on or off, and controlling the power supply to provide power to a GSM module. The command generating module is configured for generating a command that establishes a connection between the GSM module and a network, and transferring the command to the GSM module. The testing module is configured for signaling the GSM module to invoke the command, acquiring test data from the GSM module, determining whether the GSM module is normal by determining whether the GSM module is connected to the network according to the test data, and generating a test result.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a block diagram illustrating an application environment of a system for testing GSM modules in accordance with an exemplary embodiment.

FIG. 2 is a functional block diagram of the system of FIG. 1.

FIG. 3 is a flow chart illustrating a method for testing GSM modules in accordance with an exemplary embodiment.

FIG. 4 is a flow chart illustrating a method for testing GSM modules in accordance with another exemplary embodiment.

### DETAILED DESCRIPTION OF THE EMBODIMENTS

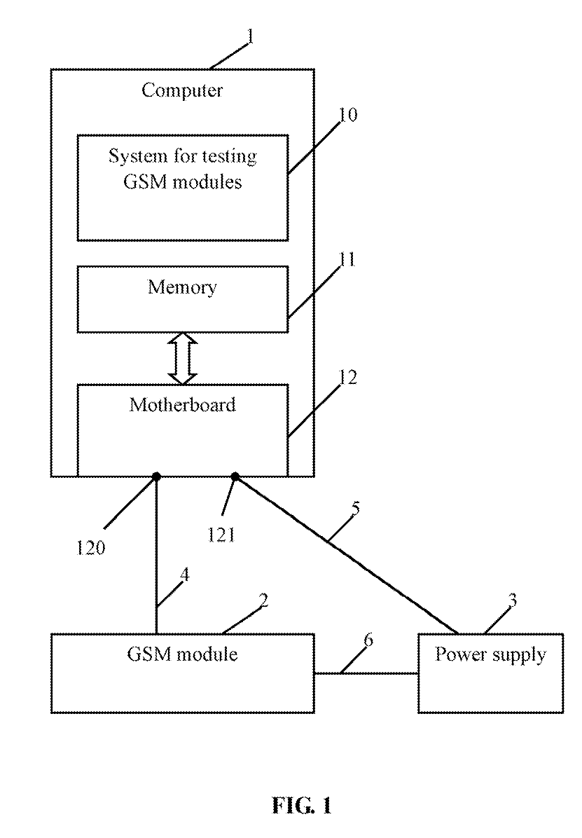

FIG. 1 is a block diagram illustrating an application environment of a system for testing GSM (global system for mobile communication) modules in accordance with an exemplary embodiment. The application environment of the system for testing GSM modules 10 (hereinafter, “the system 10”) may include a computer 1, a GSM module 2 to be tested, and a power supply 3.

The system 10 is installed in the computer 1 and is configured for testing the GSM module 2. The computer 1 includes a memory 11 and a motherboard 12. The memory 11 may be a hard disk, a flash disk, or other kinds of storage devices. The memory 11 is configured for storing various kinds of test data, such as test parameters, test results, and so on. The motherboard 12 provides a serial port 120 and an interface 121 for communicating with other electronic devices, i.e., transferring test data between the computer 1 and the electronic devices. In other embodiments, the motherboard 12 may provide other kinds of interfaces, such as parallel ports. In the present embodiment, the serial port 120 conforms to the recommended standard-232C (RS-232C), such as com1 and com2; and the interface 121 is a GPIB (general-purpose interface bus) interface.

The GSM module 2 is connected to the serial port 120 of the motherboard 12 through a data cable 4 for transferring the test data between the GSM module 2 and the computer 1, the data could be executable commands and other relevant test data, etc. The power supply 3 is connected with the interface 121 of the motherboard 12 through a GPIB cable 5. For example, the system 10 may enable or disable the power supply 3 through the GPIB cable 5 between the power supply 3 and the interface 121. The power supply 3 is also connected to the GSM module 2 through a power wire 6, so as to provide power to the GSM module 2.

The computer 1 provides an interface that enables testers to perform relevant operations. For example, the interface provides a plurality of selectable icons, which may be activated by the testers to make a selection.

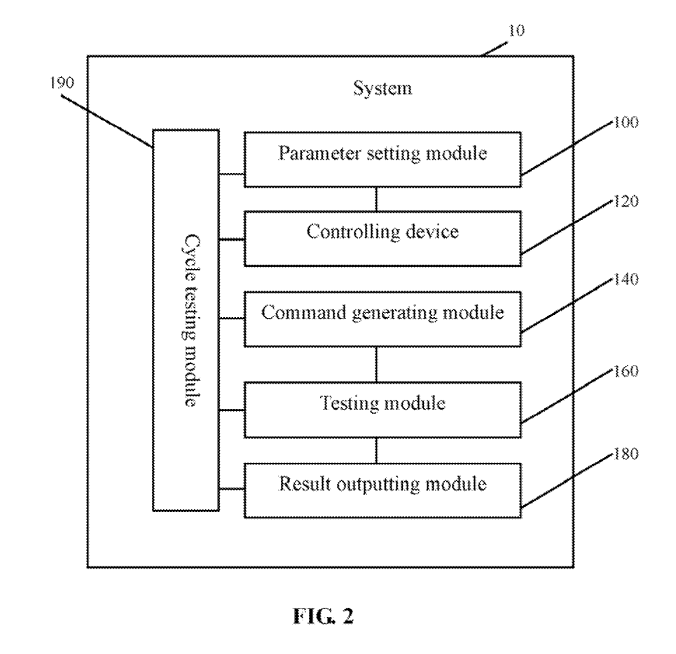

FIG. 2 is a functional block diagram of the system of FIG. 1. The system 10, installed in the computer 1, is configured for testing whether the GSM module 2 is normal. The system 10 typically includes a parameter setting module 100, a controlling device 120, a command generating module 140, a testing module 160, and a result outputting module 180.

The parameter setting module 100 is configured for setting test parameters, which comprises a range of voltages outputted by the power supply 3 when providing power, a test start time, and a test end time for controlling the test process.

The controlling device 120 is configured for switching the power supply 3 on or off according to the test start time or the test end time, and controlling the power supply 3 to provide power to the GSM module 2 according to the range of voltages. During the test, the test parameters (i.e., the range of voltages outputted by the power supply 3, etc) are configurable according to test requirements. Furthermore, the test can be controlled interactively via the interface provided by the computer 1.

The command generating module 140 is configured for generating a command that establishes a connection between the GSM module 2 to the network, and transferring the command to the GSM module 2. In the present embodiment, the generated command is an AT command, which is provided by the Windows® operating system, and is used for scheduling plans, managing tasks, etc. The AT command can be used to automatically invoke any program in the background (invisible mode) or in the foreground (interactive mode). For example, if a task of shutting down the computer 1 at 9:00 PM needs to be set, an AT command expressed as “at 21:00 ShutDown-S-T30” may be input. In other embodiments, the AT command may also be sent to the GSM module 2 via a hyper terminal program, which is provided by the Windows® operating system. The hyper terminal program may be found at “Start-Programs-Accessories-Communications-Hyper terminal.” In other embodiments, the hyper terminal program may be used for transmitting data to the serial port 120.

The testing module 160 is configured for signaling the GSM module 2 to invoke the command after the command is transferred to the GSM module 2, and acquiring relevant test data from the GSM module 2 after the command has been completed. The testing module 160 is further configured for determining whether the GSM module 2 is normal by determining whether the GSM module 2 is connected to the network according to the test data, and generating a test result. The test data may be expressed as “0” or “1”, wherein “0” represents false, and “1” represents true. In the preferred embodiment, if the test data is “1”, which represents true, the testing module 160 determines that the GSM module 2 is connected to the network, otherwise, if the test data is “0,” which represents false, the testing module 160 determines that the GSM module 2 is not connected to the network. If the GSM module 2 is connected to the network, the testing module 160 determines that the GSM module 2 is normal; otherwise, if the GSM module 2 is not connected to the network, the testing module 160 determines that the GSM module 2 is abnormal.

The result outputting module 180 is configured for generating a test report according to the test parameters, the test data and the test result, storing the test report into the memory 11, and outputting the test report. The result outputting module 180 is further configured for reporting the test report to the tester via E-mail, messages, or other communication functions.

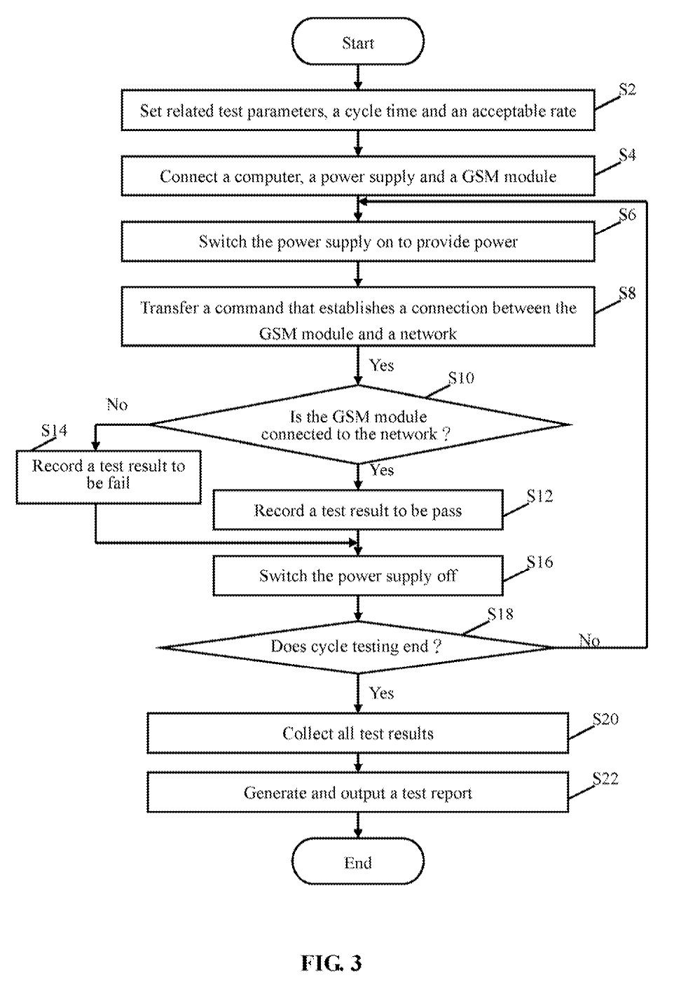

If more accurate test results are needed, the system 10 may further include a cycling testing module 190, which is configured for setting a repetition value, and performing the test repeatedly according to the repetition value (described in detail below in relation to FIG. 3). The cycling testing module 190 may predetermined a default repetition value, such as 5 times.

During cycling testing, the testing module 160 generates and records a plurality of test results, which may include two types: pass and fail. Pass means the GSM module is connected to the network, and fail means the GSM module is not connected to the network. In the cycling testing process, the testing module 160 is further configured for determining whether the GSM module 2 is normal according to an acceptable number of passes. The acceptable number is predetermined by the parameter setting module 100 before testing the GSM module 2. The acceptable number of acceptable passes may be defined by a percentage, such as 95%. Afterwards, the result outputting module 180 collects all test results recorded during the cycling testing process, the acceptable number and generates the test report.

In other embodiments, the system 10 determines whether the GSM module 2 is normal by testing whether the GSM 2 module 2 is connected to the network after a power interruption. In this embodiment, the parameter setting module 100 is further configured for setting an interruption start time and an interruption end time for power interrupt testing. The controlling device 120 is further configured for controlling the power supply 3 to interrupt power to the GSM module 2 for simulating real world unexpected power loss according to the interruption start time, and controlling the power supply 3 to restore power to the GSM module 2 according to the interruption end time.

For example, the test start time is set as 9:00 AM, the test end time is set as 9:20 AM, the range of voltages is set within 5 volts, the interruption start time is set as 9:05 AM, and the interruption end time is set as 9:10 AM. The power supply 3 is switched on by the controlling device 120 and provides power to the GSM module 2 at 9:00 AM, stops providing power to the GSM module 2 at 9:05 AM, restores power to the GSM module 2 at 9:10 AM, and stops providing power to the GSM module 2 at 9:20 AM. In other embodiments, if the interruption start time and the interruption end time are not set by the parameter setting module 100, the controlling device 120 may transmit a command of switching the power supply 3 on or off to the power supply 3 directly.

When the power supply 3 restores power to the GSM module 2 at the interruption end time, the command generating module 140 transfers the command that establishes a connection between the GSM module 2 and the network.

The testing module 160 is also configured for determining whether the GSM module 2 is normal by testing whether the GSM module 2 is connected to the network when the controlling device 120 restores power to the GSM module 2. If the GSM module 2 is connected to the network, the testing module 160 determines that the GSM module 2 is normal; otherwise, if the GSM module 2 is not power on or connected to the network, the testing module 160 determines that the GSM module 2 is abnormal.

FIG. 3 is a flow chart illustrating a method for testing GSM modules in accordance with an exemplary embodiment. In step S2, the parameter setting module 100 sets various test parameters, and the cycling testing module 190 sets the repetition value for controlling the GSM module 2 to be tested repeatedly. The test parameters include the range of voltages of the power supply 3; the test start time and the test end time for controlling the test process; and the acceptable number.

In step S4, the computer 1, the GSM module 2, and the power supply 3 are connected with each other. In step S6, the controlling device 120 switches the power supply 3 on according to the test start time, and the power supply 3 provides power the GSM module 2 according to the range of voltages.

In step S8, the command generating module 140 generates the command that establishes the connection between the GSM module 2 and the network, and transfers the command to the GSM module 2.

In step S10, the testing module 160 signal the GSM module 2 to invoke the command after the command is transferred to the GSM module 2, acquires the test data from the GSM module 2 after the command has been completed, and tests whether the GSM module 2 is connected to the network according to the test data. The test data may be “1” or “0,” which represents true or false respectively. In the present embodiment, if the test data is “1,” which represents true, the testing module 160 determines that the GSM module 2 is connected to the network, in step S12, the testing module 160 generates a test result and records the test result to be pass, and the procedure goes to step S16 directly. Otherwise, if the test data is “0,” which represents false, the testing module 160 determines that the GSM module 2 is not connected to the network, in step S14, the testing module 160 generates the test result and records the test result to be fail.

In step S16, the controlling device 120 switches the power supply 3 off according to the test end time. In step S18, the cycling testing module 190 determines whether the cycling testing ends according to the repetition value. If the cycling testing does not end, the procedure returns to step S6.

If the cycling testing ends, in step S20, the result outputting module 180 collects all test results recorded during the cycling testing process, the testing module 160 determines whether the GSM module is normal by comparing a pass ratio with the preset acceptable number according to the collected test results. If the pass ratio is not less than the preset acceptable number, the GSM module is determined to be normal; otherwise, if the pass ratio is less than the preset acceptable number, the GSM module is determined to be abnormal. In step S22, the result outputting module 180 generates and outputs the test report including the test results, and reports the test report to the tester via E-mail, messages or other communication functions.

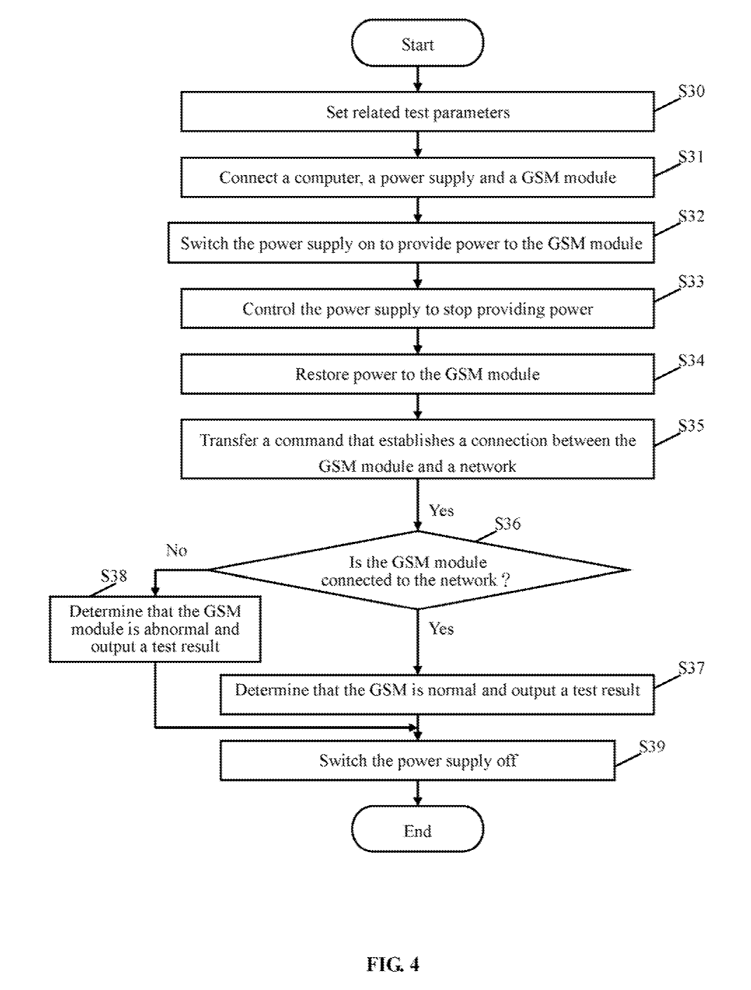

FIG. 4 is a flow chart illustrating a method for testing GSM modules in accordance with another exemplary embodiment. In step S30, the parameter setting module 100 sets related test parameters including the range of voltages of the power supply 3, the test start time and the test end time for controlling the test process, the interruption start time and the interruption end time for power interrupt testing.

In step S31, the computer 1, the GSM module 2, and the power supply 3 are connected to each other. In step S32, the controlling device 120 switches the power supply 3 on according to the test start time, and the power supply 3 provides power to the GSM module 2 according to the range of voltages.

In step S33, the controlling device 120 controls the power supply 3 to stop providing power to the GSM module 2 according to the interruption start time. In step S34, the controlling device 120 controls the power supply 3 to restore power to the GSM module 2 according to the interruption end time.

In step S35, the command generating module 140 generates the command that establishes the connection between the GSM module 2 and the network, and transfers the command to the GSM module 2.

In step S36, the testing module 160 signal the GSM module 2 to invoke the command after the command is transferred to the GSM module 2, acquires the test data from the GSM module 2 after the command has been completed, and tests whether the GSM module 2 is connected to the network according to the test data. The test data may be “1” or “0,” which represents true or false respectively. If the test data is “1,” which represents true, the testing module 160 determines that the GSM module 2 is connected to the network; otherwise, if the test data is “0,” which represents false, the testing module 160 determines that the GSM module 2 is not connected to the network.

If the GSM module 2 is connected to the network, in step S37, the testing module 160 determines that the GSM module 2 is normal and generates the test result, and the result outputting module 180 outputs the test result. If the GSM module 2 is not connected to the network, in step S38, the testing module 160 determines that the GSM module 2 is abnormal and generates the test result, and the result outputting module 180 outputs the test result and reports the test result to the tester. In step S40, the controlling device 120 switches the power supply 3 off according to the test end time.

The above-described illustration of FIG. 4 shows a singular test process to test whether the GSM module 2 is normal via simulating real world unexpected power loss. In other embodiments, the GSM module 2 may be tested repeatedly by controlling the cycling testing module 190 as described in FIG. 3.

It should be emphasized that the above-described embodiments, particularly, any “preferred” embodiments, are merely possible examples of implementations, and set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s), and the present invention is protected by the following claims.

What is claimed is:

1. A system for testing GSM modules, comprising:
a controlling device configured for switching a power supply on or off, and controlling the power supply to provide power to a GSM module;
a command generating module configured for generating a command that establishes a connection between the GSM module and a network, and transferring the command to the GSM module; and
a testing module configured for signaling the GSM module to invoke the command, acquiring test data from the GSM module, determining whether the GSM module is normal by determining whether the GSM module is connected to the network according to the test data, and generating a test result.

2. The system as claimed in claim 1, further comprising a cycling testing module configured for setting a repetition value, and performing the test repeatedly according to the repetition value.

3. The system as claimed in claim 1, further comprising a parameter setting module configured for setting test parameters that comprises a range of voltages outputted by the power supply, a test start time, and a test end time.

4. The system as claimed in claim 3, further comprising a result outputting module configured for generating a test report according to the test parameters and the test result, and outputting the test report.

5. The system as claimed in claim 3, wherein the parameter setting module is further configured for setting an interruption start time and an interruption end time.

6. The system as claimed in claim 5, wherein the controlling device is further configured for controlling the power supply to stop providing power to the GSM module according to the interruption start time, and controlling the power supply to restore power to the GSM module according to the interruption end time.

7. The system as claimed in claim 6, wherein the testing module is further configured for determining whether the GSM module is connected to the network after the controlling device restores providing power to the GSM module.

8. The system as claimed in claim 1, wherein the test data comprises “1” or “0” for representing true or false respectively.

9. A computer-implemented method for testing GSM modules, the method comprising:
switching a power supply on;
controlling the power supply to provide power to a GSM module;
generating a command that establishes a connection between the GSM module and a network;
transferring the command to the GSM module;
signaling the GSM module to invoke the command, and acquiring test data from the GSM module;
determining whether the GSM module is normal by determining whether the GSM module is connected to the network;
switching the power supply off; and
generating a test result.

10. The method according to claim 9, wherein the determining step comprises:
determining that the GSM module is normal if the GSM module is connected to the network; and
determining that the GSM module is abnormal if the GSM module is not connected to the network.

11. The method according to claim 9, further comprising:
setting a repetition value before the switching on step; and
performing the test repeatedly from the step of switching the power supply on to the step of switching the power supply off according to the repetition value.

12. The method according to claim 9, further comprising:
setting test parameters that comprises a range of voltages outputted by the power supply, a test start time, and a test end time.

13. The method according to claim 12, further comprising:
generating a test report according to the test parameters and the test result, and outputting the test report.

14. The method according to claim 12, further comprising:
setting an interruption start time and an interruption end time before the step of switching the power supply on;
controlling the power supply to stop providing power to the GSM module according to the interruption start time after the determining step; and
controlling the power supply to restore power to the GSM module according to the interruption end time.

15. The method according to claim 14, further comprising:
determining whether the GSM module is connected to the network after restoring power to the GSM module.

16. The method according to claim 9, wherein the test data comprises “1” or “0” for representing true or false respectively.
